(19) United States
(12) Patent Application Publication
(10) Pub. No.: US 2024/0125702 A1
(43) Pub. Date: Apr. 18, 2024

(54) METHOD AND APPARATUS FOR MEASURING A SURFACE CHARGE DISTRIBUTION, METHOD AND APPARATUS FOR MEASURING AN ELECTRICAL PROPERTY OF ENTITIES IN A LIQUID

(71) Applicant: Oxford University Innovation Limited, Oxford (GB)

(72) Inventor: Madhavi KRISHNAN, Oxford (Oxfordshire) (GB)

(21) Appl. No.: 18/275,262

(22) PCT Filed: Feb. 4, 2022
(86) PCT No.: PCT/GB2022/050301

§ 371 Date: Aug. 1, 2023

(30) Foreign Application Priority Data
Feb. 5, 2021 (GB) 2101623.3

(51) Int. Cl. G01N 21/64

(52) U.S. Cl. CPC G01N 21/6428; G01N 2021/6439

(57) ABSTRACT

Methods and apparatus for measuring a surface charge distribution and/or electrical properties of entities in a liquid are disclosed. In one arrangement, a liquid (2) is provided in contact with a target surface (4). The liquid (2) contains charged entities (6). A concentration of the charged entities (6) in a region between a probe member (8) contacting the liquid (2) and the target surface (4) is detected at each of a plurality of different positions on the target surface (4). A surface charge distribution on the target surface (4) is determined using the detected concentrations.

The present disclosure relates to measuring spatial variations of charge on surfaces in contact with a liquid and/or electrical properties of entities such as molecules or ions in a liquid.

Surface electrical charge is a fundamental characteristic of most materials immersed in a fluid, and generally arises from the association or dissociation of ions to or from the surface. It has proven difficult, however, to provide methods to allow such charge distributions to be measured quickly and accurately.

There is also interest in detecting electrical properties of entities such as molecules and ions in solution. Measurement of such properties can provide information that is useful in various contexts, such as in the determination of protein isoelectric points, binding affinities, and in immunosensing.

It is an object of the present disclosure to provide ways of improving determination of surface charge distributions and/or detection of electrical properties of entities in liquid.

According to an aspect of the invention, there is provided a method of measuring a surface charge distribution, comprising: providing a liquid in contact with a target surface, the liquid containing charged entities; detecting a concentration of the charged entities in a region between a probe member contacting the liquid and the target surface at each of a plurality of different positions on the target surface; determining a surface charge distribution on the target surface using the detected concentrations.

Thus, a method is provided that allows a surface charge distribution to be obtained rapidly and reliably using relatively inexpensive equipment. The method can be implemented for example using standard optical microscopy techniques. Providing the probe member with a small tip surface and scanning finely over the target surface allows very high spatial resolution maps of surface charge distribution to be obtained.

According to an alternative aspect, there is provided a method of measuring an electrical property of entities in a liquid, comprising: providing a liquid containing target entities in a region delimited by channel walls facing into the liquid, wherein the channel walls define a plurality of test regions in which a distance between the channel walls is different; detecting concentrations of the target entities in the test regions; and determining an electrical property of the target entities using the detected concentrations.

Thus, a methodology is provided that allows electrical properties of entities in solution to be obtained rapidly and reliably using relatively inexpensive equipment. The method can again be implemented for example using standard optical microscopy techniques. This approach further requires only very small amount of sample (attomoles) and will enable rapid measurement of isoelectric points of proteins, and assessment of binding interactions.

According to an alternative aspect, there is provided a method of measuring an electrical property of entities in a liquid, comprising: providing a liquid containing target entities in a region delimited by channel walls facing into the liquid, wherein at least one of the channel walls defines a plurality of nanoscale recesses acting as electrical potential wells with respect to the target entities, the distance between a base of a nanoscale recess and the channel wall facing the nanoscale recess being different for two or more of the nanoscale recesses; detecting residence times of the target entities in the electrical potential wells; and determining an electrical property of the target entities using the detected residence times.

Again, a methodology is provided that allows electrical properties of entities in solution to be obtained rapidly and reliably using relatively inexpensive equipment. The method can be implemented using standard optical microscopy techniques. The approach further requires only very small amount of sample (attomoles) and will enable rapid measurement of isoelectric points of proteins, and assessment of binding interactions.

According to an alternative aspect, there is provided an apparatus for measuring a surface charge distribution, comprising: a liquid handling apparatus configured to allow a liquid to be provided in contact with a target surface; a probe member; a detection system configured to detect a concentration of charged entities between the probe member and the target surface at each of a plurality of different positions on the target surface; and an analysis unit configured to determine a surface charge distribution on the target surface using the detected concentrations of the charged entities.

According to an alternative aspect, there is provided an apparatus for measuring an electrical property of entities in a liquid, comprising: a liquid handling apparatus configured to allow a liquid to be provided in a region delimited by channel walls facing into the liquid, wherein the channel walls define a plurality of test regions in which a distance between the channel walls is different; a detection system configured to detect concentrations of target entities in the test regions; and an analysis unit configured to determine an electrical property of the target entities using the detected concentrations.

According to an alternative aspect, there is provided an apparatus for measuring an electrical property of entities in a liquid, comprising: a liquid handling apparatus configured to allow a liquid to be provided in a region delimited by channel walls facing into the liquid, wherein at least one of the channel walls defines a plurality of nanoscale recesses acting as electrical potential wells with respect to the target entities, the distance between a base of a nanoscale recess and the channel wall facing the nanoscale recess being different for two or more of the nanoscale recesses; a detection system configured to detect residence times of the target entities in the electrical potential wells; and an analysis unit configured to determine an electrical property of the target entities using the detected residence times.

Embodiments of the disclosure will now be further described, merely by way of example, with reference to the accompanying drawings.

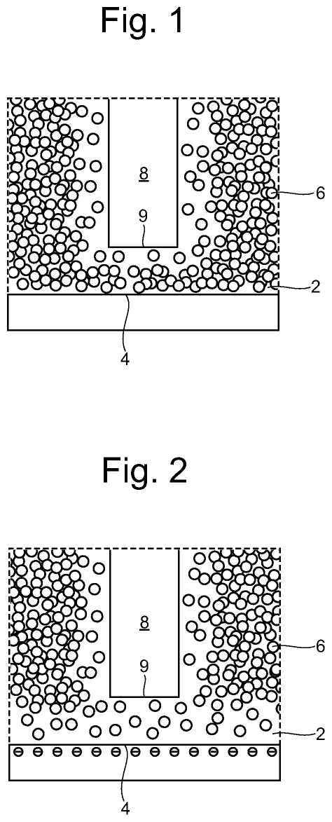

FIG. 1 is a schematic side sectional view of a region around a charged probe member in a liquid containing charged entities over a target surface.

FIG. 2 is a schematic side sectional view of the arrangement of FIG. 1 in a case where the target surface has a surface electrical charge of the same sign or electrical potential of the same polarity as the charged entities in the liquid.

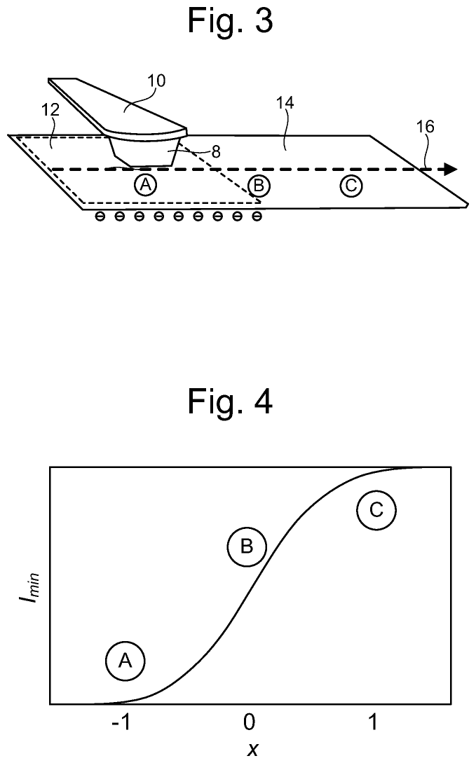

FIG. 3 is a schematic perspective view showing scanning of a cantilever arrangement having a probe member over a target surface having a charged region and an uncharged region.

FIG. 4 is a graph showing a variation in a detected minimum optical intensity Iₘᵢₙ as a function of position of the probe member during the scanning depicted in FIG. 3.

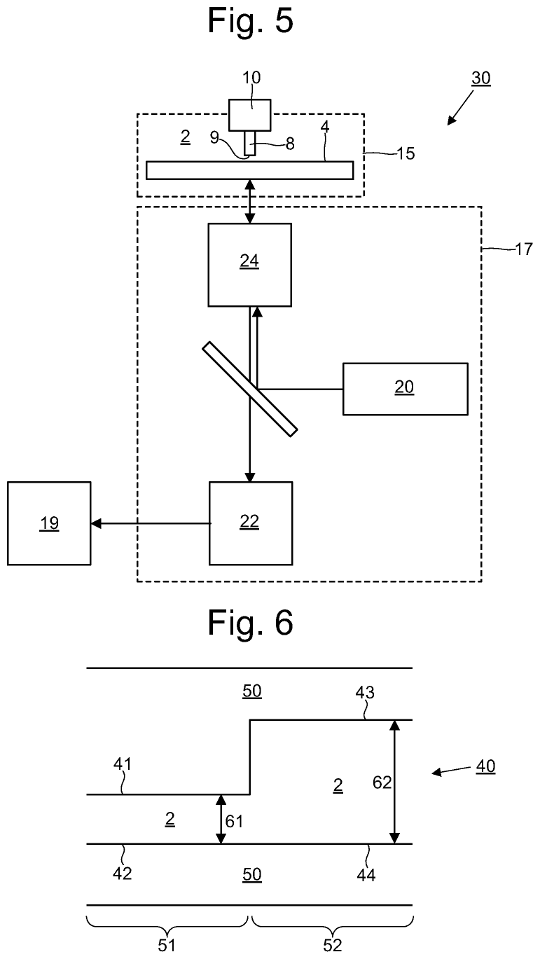

FIG. 5 schematically depicts an apparatus for measuring a surface charge distribution and/or an electrical property of entities in a liquid.

FIG. 6 is a schematic side sectional view showing two example test regions for detecting an electrical property of entities in a liquid.

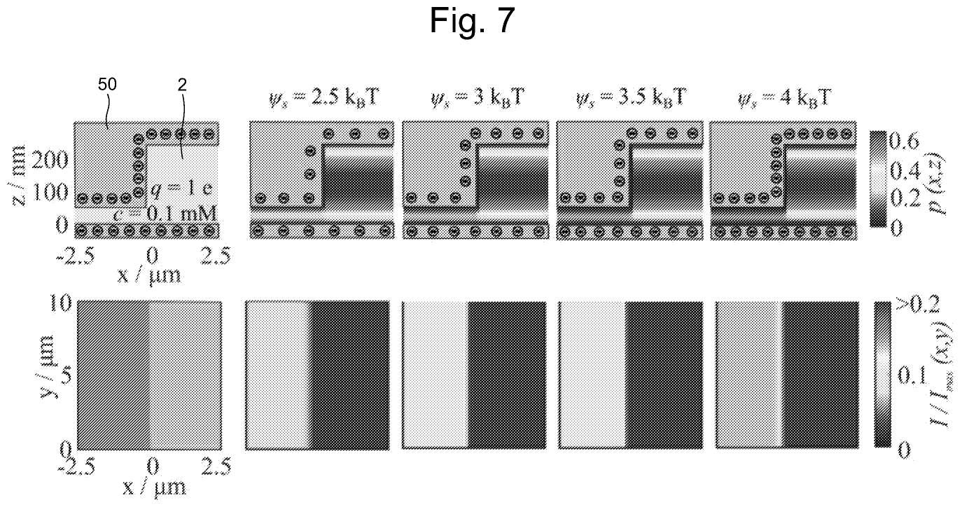

FIG. 7 (top row) depicts calculated spatial probability distributions p(x, z) in an x-z plane for a reference entity in an arrangement of the type shown in FIG. 6 for different electrical potentials arising from surface charge density or applied to channel walls, with the leftmost image defining the geometry, charge, and concentration of entities present.

FIG. 7 (bottom row) depicts respective calculated microscope images obtained by viewing each of the arrangements of FIG. 7 (top row) parallel to the y-direction, with the leftmost image defining the geometry.

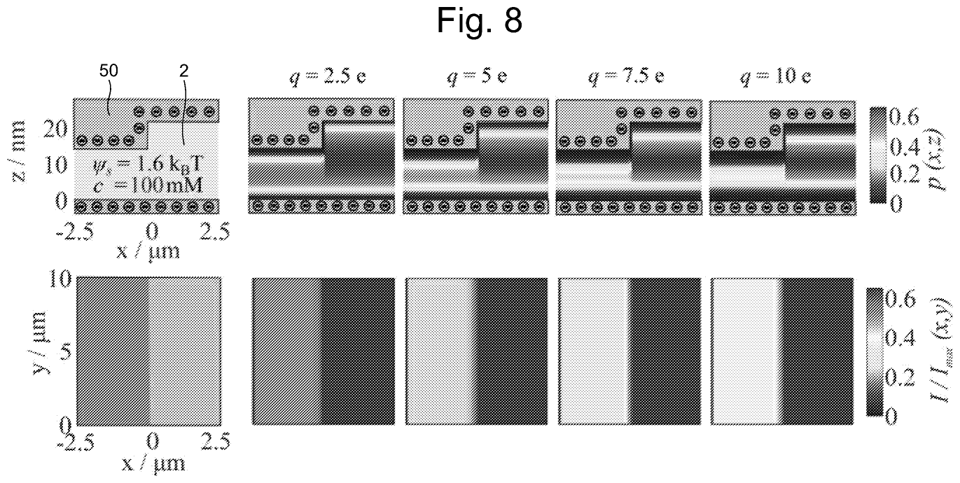

FIG. 8 (top row) depicts calculated spatial probability distributions p(x, z) in the x-z plane for theoretical cases where the target entity has a charge q equal to 2.5 e, 5 e, 7.5 e and 10 e respectively, with the leftmost image defining the geometry, applied potential, and concentration of entities present.

FIG. 8 (bottom row) depicts respective calculated microscope images obtained by viewing each of the arrangements of FIG. 8 (top row) parallel to the y-direction, with the leftmost image defining the geometry.

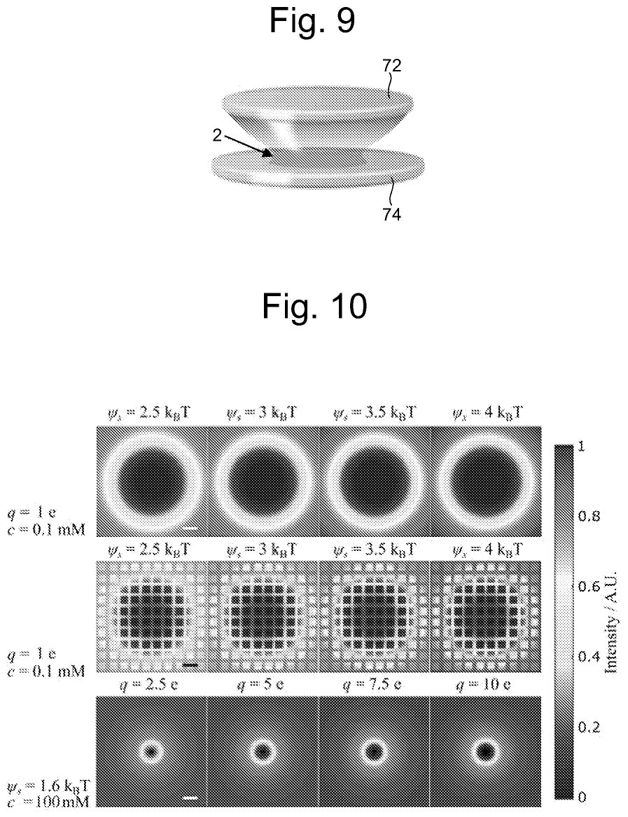

FIG. 9 is a schematic perspective view showing an alternative arrangement for measuring an electrical property of entities in a liquid.

FIG. 10 (first row) shows calculated images from the arrangement of FIG. 9 acquired for surfaces carrying increasing values of surface charge (indicated by the value of surface electrical potential ψₛ increasing from left to right).

FIG. 10 (second row) depicts calculated images corresponding to those of FIG. 10 (first row) except that a periodic pattern in surface charge is provided on the test surface.

FIG. 10 (third row) depicts intensity images calculated for a common surface charge and therefore electrical potential on the channel walls and differing charges on the entities in the liquid.

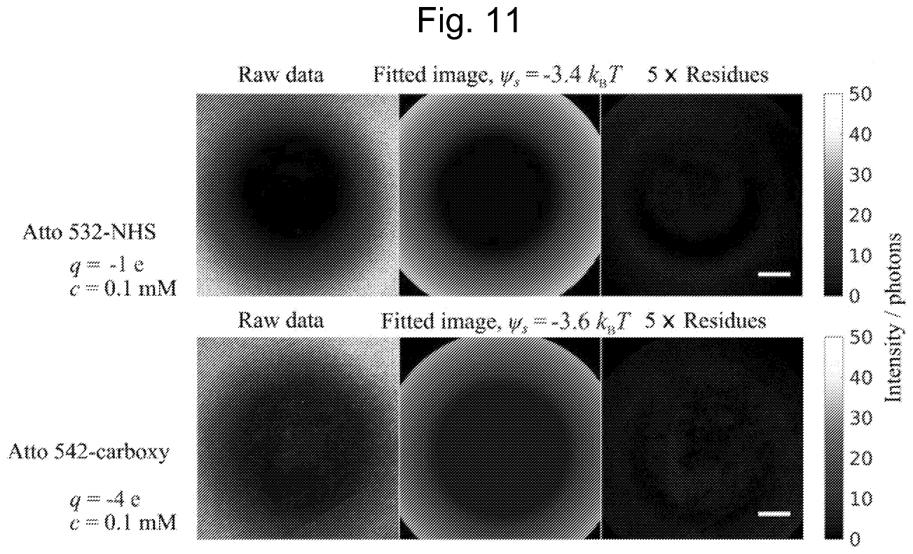

FIG. 11 (top row) depicts experimentally obtained raw, preliminary data from an arrangement of the type depicted in FIG. 9 using a dye molecule with charge q equal to −1 e, along with a calculated image and an image of residues which refers to the difference between the measured and calculated image. Residue values close to zero imply excellent agreement between theory and practice and serve as proof of concept.

FIG. 11 (bottom row) depicts experimentally obtained raw, preliminary data from an arrangement of the type depicted in FIG. 9 using a dye molecule with charge −4 e, along with a calculated image and a residual image.

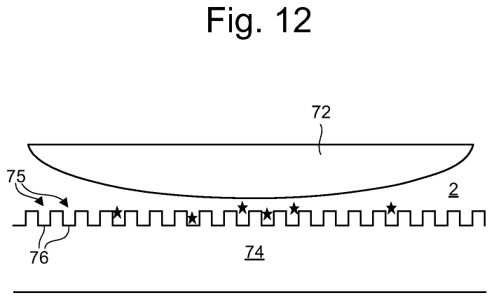

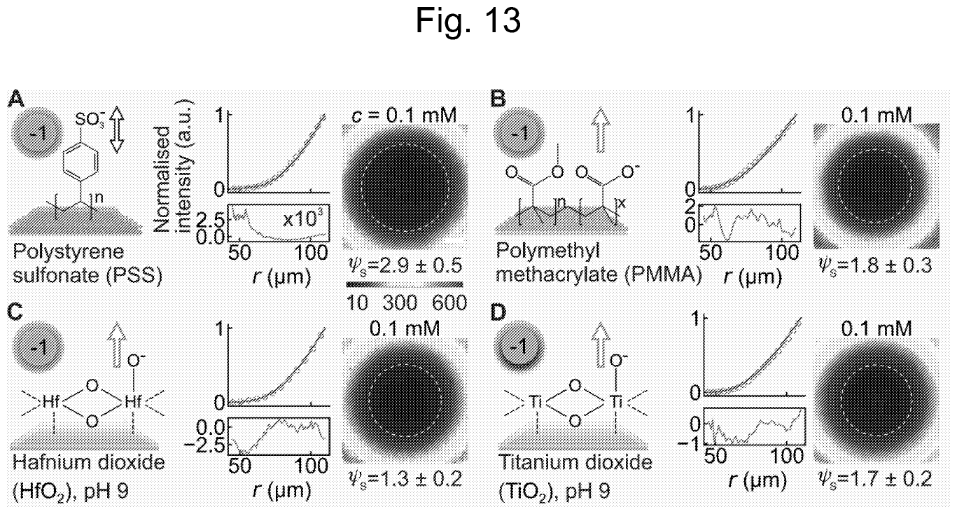

FIG. 12 depicts a lens forming a smoothly curved channel wall facing a substrate defining a plurality of nanoscale recesses defining respective electrical potential wells.

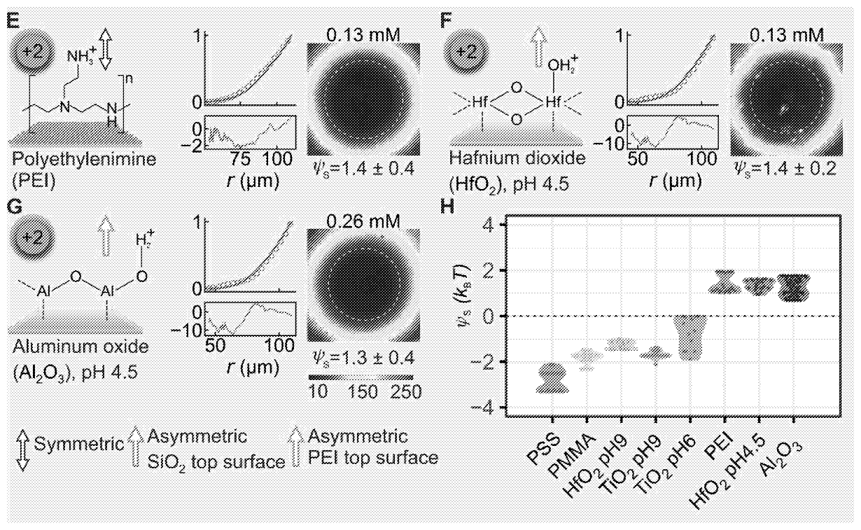

FIGS. 13A-G demonstrate characterisation of the electrical surface potentials of polymer, polyelectrolyte, and inorganic oxide thin film coatings.

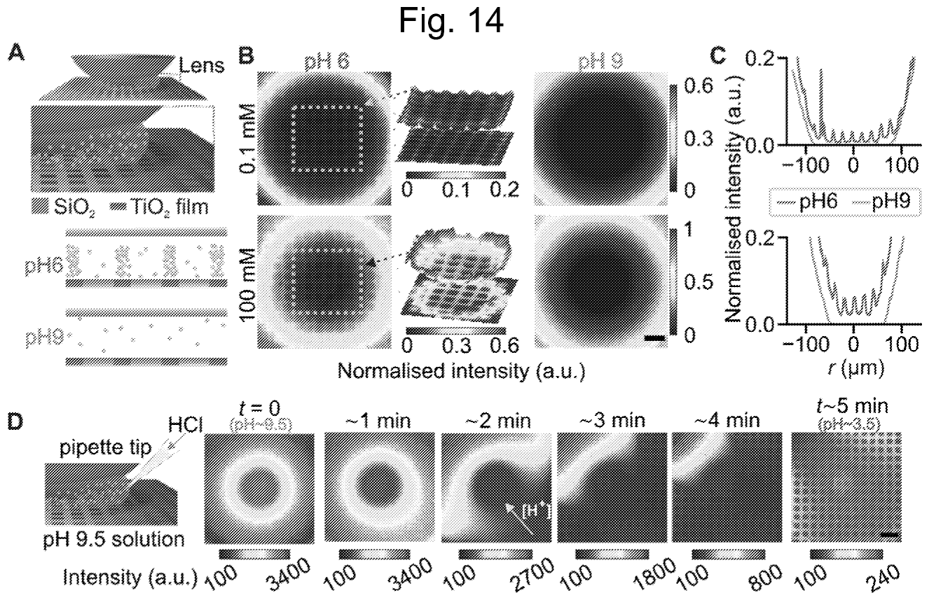

FIGS. 14A-D show spatiotemporal measurement of electrostatic contrast in TiO₂ thin film patterns on glass coverslips.

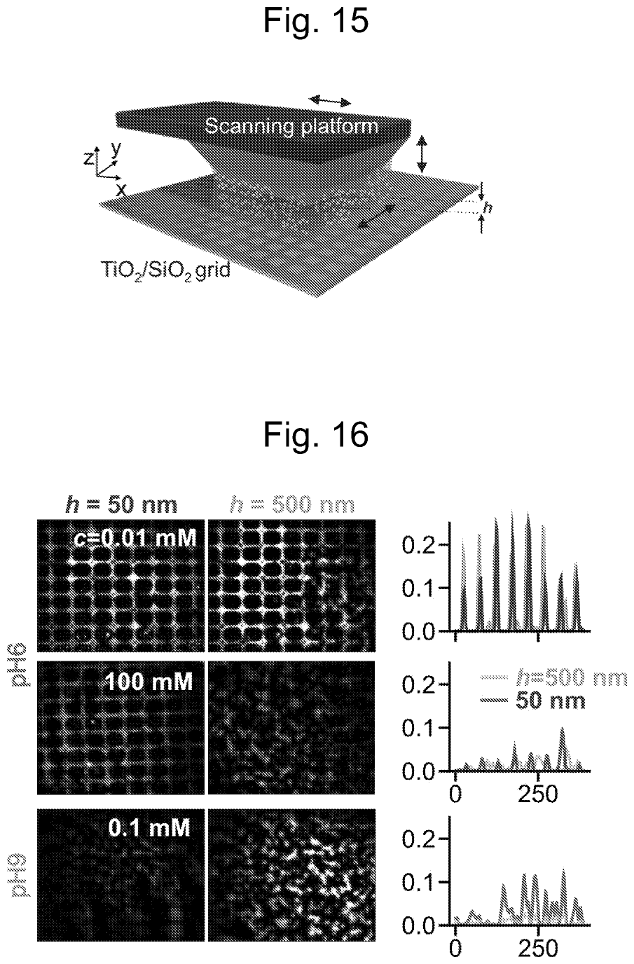

FIG. 15 is a schematic of an example scanning probe system applied to electrostatic contrast measurements of TiO₂/SiO₂ substrates.

FIG. 16 shows images of fluorescence intensity distributions obtained using the system of FIG. 15 at two distinct heights of the scanning platform, for low and high ionic strength solutions at pH6, and low ionic strength solution at pH9, along with plots of line intensity profiles at each condition.

Methods of measuring a surface charge distribution are disclosed. The surface charge distribution is a spatial variation of charge density (charge per unit area as a function of position) over a surface in contact with a liquid. The surface charge distribution may be spatially non-uniform. A spatially non-uniform surface charge distribution may arise, for example, due to spatial variations in the composition and/or topology of the surface being measured. Example methods are described below with reference particularly to FIGS. 1-5 and FIGS. 13-16, where FIG. 5 depicts an example apparatus 30 for carrying out some of the methods.

As depicted schematically in FIGS. 1 and 2, an arrangement is provided in which a liquid 2 is in contact with a target surface 4 to be measured (i.e. the surface for which it is desired to obtain information about the spatial variation of charge density). The liquid 2 contains charged entities 6 such as molecules or ions in solution. The charged entities 6 may comprise ions having a known electrical charge in solution, typically in the range of q equals −1 e to −4 e for example, but biomolecular probes such as DNA carrying much higher charge, e.g., −50 e, may also be used for weakly charged surfaces. As depicted schematically in FIG. 5, the liquid 2 may be handled (e.g. provided and/or contained) by a liquid handling apparatus 15. The liquid handling apparatus 15 may comprise any known combination of hardware elements (e.g. liquid reservoirs, ducting, valves, temperature control systems, etc.) necessary to deal with the liquid 2.

A probe member 8 is provided in the liquid 2. The probe member 8 may be fully submerged in the liquid 2 or comprise a portion in the liquid 2 and a portion that is not in the liquid 2. The probe member 8 comprises a tip surface 9 that contacts the liquid 2. The tip surface 9 faces a portion of the target surface 4 to be measured. The tip surface 9 may be provided relatively close to the target surface 4 (e.g. roughly between 50-200 nm separation) such that there is only a thin film of the liquid 2 and charged entities 6 between the tip surface 9 and the target surface 4. The size and shape of the tip surface 9 is not particularly limited but may have a characteristic length scale (e.g. diameter or width) in the region of 10-30 nm for example. The probe member 8 may be provided on a cantilever arrangement 10 (as depicted schematically in FIG. 3). Similar to target surface 4 the probe member 8 may be made of a material that spontaneously acquires surface charge and therefore surface electrical potential when exposed to liquid 2. The probe member 8 may be configured to allow external charging of the probe member 8 (i.e. application of an electrical potential to the probe member 8). The probe member 8 may be charged (either spontaneously on contact with the liquid 2 or via an externally applied field) so as to have an electrical potential of the same polarity as the charged entities 6 in the liquid 2. Charging the probe member 8 in this way causes the charged entities to be repelled from the probe member 8, as depicted schematically in FIG. 1. The concentration of the charged entities 6 is reduced in the region directly adjacent to the probe member 8 in comparison to other regions within the liquid 2.

If the target surface 4 is charged with the same polarity as the charged entities 6, as depicted schematically in FIG. 2, the charged entities 6 will be repelled from the target surface 4 and the probe member 8. The concentration of the charged entities 6 is thereby reduced further in the region between the probe member 8 and the target surface 4. The reduction in average concentration becomes easily detectable if the separation between the probe member 8 and target surface 4 is made sufficiently small. Furthermore, the average concentration becomes a strong function of the charge density on the portion of the target surface 4 opposite to the probe member 8. Lowering the charge density will increase the concentration and increasing the charge density will lower the concentration. Detecting the average concentration in the region between the probe member 8 and the target surface 4 thus provides a measure of the local charge density on the target surface 4. In some embodiments, a theoretical model may be used to convert between the detected concentrations of charged entities and absolute values of local surface charge density.

In some embodiments, the above effects are exploited to measure the charge density at a plurality of different positions on the target surface 4 and thereby derive a surface charge distribution for the target surface 4. In some embodiments, this is achieved by using a detection system 17 to detect a concentration (e.g. a spatially averaged concentration) of the charged entities 6 in a region between the probe member 8 and the target surface 4 (e.g. between a tip surface 9 and a portion of the target surface 4 facing the tip surface 9) at each of a plurality of different positions on the target surface 4 (e.g. for different respective portions of the target surface 4 facing the tip surface 9). Thus, each position on the target surface 4 that is being measured may correspond to a small portion of the target surface 4 and the concentration of the charged entities that is measured to determine the surface charge density in the small portion may be the concentration of charged entities that are present in a region between (delimited by) that small portion and the probe member 8 (e.g. tip surface 9). This may be achieved at least partly, for example, by detecting a concentration for each of a plurality of different positions of the probe member 8 relative to the target surface 4. The method may therefore comprise providing relative movement between the probe member 8 and the target surface 4 in order to provide the different positions of the probe member 8 relative to the target surface 4. The relative movement may be provided by moving either or both of the probe member 8 and the target surface 4 as described below. Alternatively or additionally, the method may detect a spatial variation in the concentration of the charged entities as a function of position over the target surface 4 for a given position of the probe member 8 relative to the target surface 4. This allows spatial measurements of variations in surface charge density to made at a higher spatial resolution (e.g., at resolutions smaller than a surface area of the tip surface 9 facing the target surface 4). Each detected concentration provides information about the surface charge density at a respective portion of the target surface 4. The surface charge distribution may thus be determined using the detected concentrations. The results may be stitched together to provide a map of the surface charge density (an example representation of a surface charge distribution). As mentioned above, a theoretical model may be used to convert between the detected concentrations of charged entities and absolute values of local surface charge density. In some embodiments, data processing to derive the surface charge distribution may be performed by an analysis unit 19, as depicted in FIG. 5. The analysis unit 19 may comprise any known combination of data processing hardware, firmware and software suitable for performing the desired data processing operations.

In some embodiments, the concentrations of the charged entities are detected optically. Light may thus be directed into the region between the probe member 8 and the target surface 4 to interact with the liquid 2 and charged entities 6. Light emitted from the region is detected and used to infer the concentration of charged entities in the region. In some embodiments, light from the region passes through the target surface 4 before being detected. In the orientation of FIGS. 1 and 2, the light would thus be detected from below. In some embodiments, the charged entities 6 are fluorescent such that a detected intensity is higher where more of the charged entities are encountered. In such cases, the shallow region of liquid 2 between the probe member 8 and the target surface 4 may correspond to a lowest detected intensity, Iₘᵢₙ, in a detected image. The relevant region of the image can thus be easily located. Observing how Iₘᵢₙ varies for different positions of the probe member 8 relative to the target surface 4 provides information about a corresponding variation in the local charge density on the target surface 4.

An example of such a variation of/min with position x (parallel to an x axis) is depicted in FIG. 4. The depicted variation corresponds to the illustrative case of FIG. 3, in which a probe member 8 on a cantilever arrangement 10 is scanned over a target surface 4 having a charged region 12 and an uncharged region 14. The charged and uncharged regions 12, 14 may be provided by applying suitable coatings to the surfaces. An uncharged surface may be achieved for example by coating with a layer of hydrophobic molecules. In this example, the probe member 8 is scanned along direction 16 parallel to the x axis. It can be seen that/min is minimal when the probe member 8 is in region “A” opposite a central portion of the charged region 12 (corresponding to the situation of FIG. 2), rises to an intermediate value at the boundary region “B” between the charged region 12 and the uncharged region 14, and reaches a maximum value when the probe member 8 is in region “C” opposite a central portion of the uncharged region 14 (corresponding to the situation of FIG. 1).

As mentioned above, the charged entities 6 may be fluorescent (e.g. fluorescent molecules or molecular ions). The use of fluorescent entities helps to ensure that an optical signal, for example/min, is a sensitive function of the concentration of charged entities in the region being sensed. The choice of fluorescent entity is not particularly limited. The fluorescent entities may, for example, comprise fluorescent dye molecules such as Atto 532 NHS ester (Atto-Tec GmbH), which is known to carry a unit negative charge over a wide range of pH values (from pH 1 to pH 9).

In embodiments where the charged entities are fluorescent, a light source such as a laser 20 may be used to excite the fluorescence during the detection of the concentrations of charged entities, as exemplified schematically in FIG. 5. Light from the laser 20 at a wavelength suitable for exciting the fluorescence is directed through a microscope objective lens 24 and through the target surface 4 to interact with the charged entities in the region between the probe member 8 and the target surface 4. Light emitted from the fluorescing charged entities is collected by the same objective lens 24 and directed to a detection unit 22. The detection unit 22 may comprise optics for forming an image, filters for removing unwanted light, diffusers to scatter laser light, optical components for scanning the laser beam, and/or a sensor unit for capturing the image, such as a CCD camera or photodiode. An intensity minimum, Iₘᵢₙ, in the captured image represents the average concentration of fluorescent molecules in the region between the probe member 8 and the target surface 4.

As mentioned above, the concentration of the charged entities between the probe member 8 and the target surface 4 is detected at each of plural different positions on the target surface 4, for example by positioning the probe member 8 at plural different locations relative to the target surface 4. This may be achieved by moving the probe member 8 while keeping the target surface 4 stationary, moving the target surface 4 while keeping the probe member 8 stationary, or by a combination of simultaneously moving the target surface 4 and the probe member 8. The movement may be continuous or intermittent. The movement may be referred to as scanning and/or may take the form of a raster scan. The movement may cause the probe member 8 to scan over the target surface 4 in two dimensions to build up a two-dimensional map of the surface charge density that represents the surface charge distribution. A focused laser beam may also be scanned across the entire area of interest. A separation between the probe member 8 and the target surface 4 may be kept constant during the movement or may be varied.

Alternatively, a static approach may be used in which distinct concentrations are measured at plural different positions between the probe member 8 and the target surface 4 while keeping the probe member 8 and the target surface 4 stationary relative to each other. The probe member 8 may, for example, be provided with a plurality of distinct tip surfaces 9 that are spatially separated from each other. Each such tip surface 9 may comprise an individual projection that closely approaches the target surface 4. Directly adjacent portions of the probe member 8 may be recessed relative to each projecting tip surface 9. Alternatively, the probe member 8 may be provided with a tip surface 9 that is large enough that meaningful spatial variations in concentration can be observed adjacent to different portions of the tip surface 9 for a single position of the tip surface 9 relative to the target surface 4. By moving the probe member 8 to different positions relative to the target surface it is possible to obtain a continuous map of surface charge density over the target surface.

In some embodiments, the probe member 8 comprises a relatively large probe surface facing the target surface and spatial variations of a measured concentration of the charged entities between the probe surface and the target surface may be used to determine a topography of the target surface.

In some embodiments, the method is repeated with different liquid compositions. The different liquid compositions may, for example, include different pH values and/or ionic strengths. These measurements allow surface chemical properties to be inferred, such as the ionization constants of the surface chemical groups in the liquid (solvent) of interest.

The relationship between the concentration of charged entities in a gap between two surfaces and the surface charge density on the surfaces can also be used to determine unknown information about an electrical property of entities in the gap (e.g. the charge of the entities). Example methods of measuring such an electrical property are described below. These methods may also be implemented using elements of the apparatus 30 of FIG. 5, including the liquid handling apparatus 15, the detection system unit 17 and the analysis unit 19.

In an embodiment, as exemplified in FIG. 6, the method comprises providing a liquid 2 containing target entities in a region 40 delimited by channel walls 41-44 facing into the liquid 2. In the example shown, the region 40 is defined in a containing structure 50. The containing structure 50 may be transparent to allow access for optical interrogation of concentrations of the target entities. In the example shown, light may enter and/or leave the region 40 through transparent walls of the containing structure 50 (e.g. vertically from below or above in the orientation shown in FIG. 6). The channel walls 41-44 define a plurality of test regions 51, 52. A distance (or average distance) between the channel walls 41-44 is different in each of the test regions 51, 52. In the example shown, two test regions 51 and 52 are provided. A single body of liquid 2 extends through all of the test regions 51-52. The test regions are thus all in continuous liquid communication with each other. The distance between the channel walls 41 and 42 defining test region 51 is indicated by arrow 61. The distance between the channel walls 43 and 44 defining test region 52 is indicated by arrow 62. The different distances between the channel walls 41-44 in the different test regions 51, 52 is implemented in this example by providing a step between the channel walls 41 and 43 on the upper side of the channel, but various other approaches may be used. For example, the channel walls may be configured such that the distance between the channel walls varies continuously as a function of position along the channel walls. This may be achieved for example by arranging for the upper and/or lower channel walls to be smoothly curved. The outer surface of a convex lens may for example be used to define an upper channel wall, as described below.

An electrical potential may be applied to either or both of the channel walls 41-44 in each of the test regions 51, 52. The electrical potential may be of the same polarity as a charge of the target entities in the liquid 2 so as to repel the target entities away from the channel walls 41-44. In some embodiments, the same electrical potential is applied to all of the channel walls 41-44. Alternatively, as described above, the channels walls may be configured so that a surface charge arises spontaneously on their surfaces when contacted by the liquid 2.

As exemplified in FIG. 6, the test regions 51, 52 may be arranged so that a spatial variation in the concentration of target entities in the test regions varies as a function of one or more electrical properties of the target entities (e.g. their charge in solution). An electrical property (e.g. charge) of the target entities can then be obtained by detecting the concentrations in the test regions. In the example of FIG. 6, test region 51 is much thinner than test region 52. This results in charged target entities being forced out of test region 51, which can be detected as a fall in optical intensity from test region 51 relative to test region 52 (in a case where the entities fluoresce and are interrogated optically). The extent to which this occurs provides information about the amount of charge on each charged entity. Other optical contrast mechanisms such as absorption and scattering of light by the entities in solution may also be used to detect these concentration differences.

In some embodiments, calibration measurements are performed to assist with determining the electrical property of interest from the detected concentrations. For example, a liquid 2 containing reference entities having a known value of the electrical property (e.g. known charge) may be measured in the region delimited by channel walls 41-44 (or in an equivalent region delimited by channel walls—e.g. a region having the same dimensions and properties). Concentrations of the reference entities in the test regions 51, 52 are detected and used to assist with determination of the electrical property of interest of the target entities. The measurements using reference entities may, for example, be repeated using multiple different reference entities, multiple different surface properties in the test regions 51, 52 and/or multiple different liquid compositions to obtain a library of concentrations in the test regions that correspond to different conditions. Measurements obtained from the target entities can be compared with entries in the library to look for a closest match.

The detection of the concentrations of entities described above with reference to FIG. 6 can be performed optically in any of the ways described above with reference to FIGS. 1-5, including using fluorescence microscopy. In contrast to the scanning arrangements of FIGS. 1-5, the present approach may, however, typically be performed statically, i.e. with no relative movement between any of the channel walls 41-44 and/or liquid 2.

FIG. 7 (top row) depicts calculated spatial probability distributions p(x, z) for a reference entity (fluorescent dye molecule Atto 532 NHS ester) in an arrangement of the type described above with reference to FIG. 6. The reference entity carries a charge q equal to 1 e. The salt concentration in solution was 0.1 mM. The calculated probability distributions indicate an expected spatial variation in concentration of the reference entities, which can be detected optically as explained above. The x direction is horizontal in the plane of the page. The z direction is vertical in the plane of the page. The images are cross-sectional views along the y direction, corresponding to the viewing direction in FIG. 6. Thus, the upper and lower dark grey regions in each image represent material of the containing structure 50 and the region in between is where the liquid 2 is located and represents the test regions. The channel heights (corresponding to distances 61 and 62 shown in FIG. 6) are respectively 50 nm and 225 nm in the example shown. The channel walls may carry different amounts of electrical charge, due to different pH values, salt concentrations in solution or other chemical differences. These charge densities as indicated by the different marked electrical potentials ψₛ in units of thermal energy k_{B}T (respectively from left to right: 2.5 k_{B}T, 3 k_{B}T, 3.5 k_{B}T, 4 k_{B}T). As indicated by the top row of images in FIG. 7, marked differences are observed in the spatial variation of concentration as a function of surface charge on the channel walls. The differences are particularly visible in the shallower test region on the left, where the concentration of reference entities is significantly lower due to expulsion of the reference entities out of the test region due to repulsion from both of the closely spaced channel walls.

FIG. 7 (bottom row) depicts calculated microscope images viewed along the z direction corresponding to the regions depicted in the top row of images of FIG. 7. The observed local intensity values, I/Iₘₐₓ (x, y), make it possible to directly infer the surface charge on the channel walls.

FIG. 8 (top row) depicts calculated spatial probability distributions p(x, z) for theoretical cases where the target entity has a charge q equal to 2.5 e, 5 e, 7.5 e and 10 e respectively. The salt concentration was 100 mM. The same electrical potential ψₛ=1.6 k_{B}T develops on the surfaces in each of the four cases. As can be seen, the spatial variation of concentration of the target entities in the test regions varies significantly as a function of the charge of the target entity. The differences in spatial variation of concentration lead to different average concentrations of the target entities in the test regions, which can be detected optically, for example using any of the techniques mentioned above with reference to FIGS. 1-5.

FIG. 8 (bottom row) depicts calculated microscope images corresponding to the regions depicted in the top row of images of FIG. 8, confirming that differences in intensity I/Iₘₐₓ are observed as a function of charge of the target entity, confirming that optical measurements can be used to measure a charge of the target entities.

FIG. 9 depicts a variation on the arrangement of FIG. 6. Test regions are provided with a distance between channel walls on upper and lower sides varying continuously as a function of position along the channel walls. In the example shown, a film of liquid 2 is provided between a curved convex lens 72 on an upper side and a flat substrate 74 on a lower side. The lens 72 may be placed in contact with the substrate 74 to create a gap with continuously varying height. The lens 72 provides an upper channel wall of a continuous series of test regions and the substrate 74 provides the lower channel wall.

FIG. 10 depicts calculated images using an arrangement of the type shown in FIG. 9, with a lens 72 of known radius of curvature (e.g. of the order of a centimetre). A solution of dye molecules is provided in the gap between the lens 72 and substrate 74. A region of about 200 μm×200 μm around the contact point is imaged.

FIG. 10 (first row) shows calculated images acquired for surfaces carrying increasing values of surface charge, represented in terms of electrical potential, ψₛ. Image analysis reveals clear differences in intensity distributions for changing surface charge.

FIG. 10 (second row) depicts calculated images for a variation in which a periodic pattern in surface charge is imaged using the lens. An uncharged surface coating, which could be realised using a thin film of polymer or silane for example, creates a series of grid lines that are 5 μm wide and spaced at a 20 μm pitch. The pattern is strikingly obvious on visual inspection of the calculated fluorescence image. The exact local intensity values and level of contrast in the image depend on the local magnitude of charge on the surface. As described previously, regions on the target surface carrying low amounts of surface charge admit more fluorescent molecules in solution which registers as a brighter optical intensity than neighbouring uncoated, highly charges regions.

FIG. 10 (third row) shows how, once the surface charge on both surfaces has been determined, the charge of an unknown target entity introduced into the gap (test regions) can be readily measured. The intensity images presented were calculated using a fixed surface potential (ψₛ=1.6 k_{B}T) on both channel walls, for a molecule carrying electrical charge, q, ranging from 2.5 to 10 e in physiological salt concentration of 100 mM. Such conditions are typical for most biomolecules such as proteins in solution.

FIG. 11 depicts experimentally obtained raw, preliminary data from a lens based system such as that described above with reference to FIGS. 9 and 10 using two different dye molecules of charge −1 e (top row) and −4 e (bottom row), presented alongside a calculated result. Also presented are “residue” images depicting the difference between the experimentally recorded image and a calculated counterpart. The fact that the residues are effectively zero indicates excellent agreement between the experiment and calculation, and the level of accuracy of the inferred value of surface potential. The measured values of the surface potentials are noted above the images. Scale bars represent 40 μm.

FIG. 12 depicts a further application of the principles discussed above. Electrical properties of target entities in a liquid 2 are measured by providing the liquid 2 and target entities in a region delimited by channel walls facing into the liquid. At least one of the channel walls defines a plurality of nanoscale recesses 75. In the example shown, a lens 72 provides a channel wall on the upper side (facing down) and a substrate 74 provides a channel wall on the lower side (facing up). In the example shown, the nanoscale recesses 75 are formed in the substrate 74. The recesses 75 act as electrical potential wells with respect to the target entities. Thus, a surface charge in the recesses 75 creates an electrical field in the liquid 2 that forms a potential well. The electrical field of the potential well is influenced also by the presence of the channel wall facing the recess 75. When a target entity enters a lower energy region of the well the target entity will be temporarily trapped by the potential well. A residence time of the target entity in the potential well will vary statistically but on average will depend on the electrical field defining the potential well and the charge on the target entity. Measuring residence times of the target entities in the recesses 75 can thus be used to obtain electrical information about the target entities.

In the embodiment shown, the channel walls are configured such that the distance between a base 76 of a nanoscale recess 75 and the channel wall facing the nanoscale recess 75 (providing by the lens 72 in the example shown) are different for two or more of the nanoscale recesses 75. Residence times of the target entities in the electrical potential wells are then measured. Electrical properties of the target entities are determined using the detected residence times. The different distances between the bases 76 of the recesses 75 and the opposing surface of the lens 72 provide potential wells with a variety of different forms. Measuring how the residence times vary as a function of the different potential well properties enables more detailed information about the electrical properties of the target entities to be obtained.

In some embodiments, as exemplified in FIG. 12, a channel wall facing the nanoscale recesses 75 is smoothly curved, thereby providing a range of different distances between the bases 76 of the nanoscale recesses 75 and the channel wall facing the nanoscale recesses 75. In other embodiments, the smoothly curved surface may be provided with one or more steps or other abrupt variations in geometry, or replaced entirely by a surface having a stepped profile.

The above-described use of nanoscale recesses may be applied to embodiments of the type described above with reference to FIG. 6. Thus, test regions may be formed that comprise nanoscale recesses acting as electrical potential wells with respect to the target entities. The detecting of the concentrations of the target entities in the test regions may then comprise detecting residence times of the target entities in the potential wells. Detecting a residence time effectively involves detecting how long a local concentration of the target entities is high in a potential well.

FIGS. 13A-G demonstrate use of the lens-based geometry of FIG. 9 to characterise the electrical surface potentials of polymer, polyelectrolyte, and inorganic oxide thin film coatings. In each case, the leftmost sub-figure is a schematic showing the chemical structure of the target substrate on top of a coverglass, the charge of a probe fluorescent molecule (charged entity), and an arrow indicating whether the variable height gap was a symmetric (same material on both flanking surfaces) or asymmetric system. FIGS. 13A-D show results for negatively charged materials. FIGS. 13E-G show results for positively charged materials. A representative fit of the normalized 1(r) (intensity as a function of radius) curves measured for each material is shown with the corresponding fit residues below, along with a representative image of the imaged fluorescent distribution, with the dashed white contour line at 40 counts. FIG. 13H shows summary statistics of the estimated surface potentials for all materials in FIGS. 13A-G.

Embodiments of the disclosure were applied to examining surfaces with a heterogeneous surface charge distribution (i.e., a spatially non-uniform surface charge distribution). A model heterogeneous surface was constructed by coating silica coverslips with −10 nm thick TiO₂ film and using optical lithography and etching to pattern a periodic square grid pattern with a 10 μm pitch. FIG. 14A is a schematic of the lens-based geometry used, with a variable-height gap (top) and a grid of TiO₂ lines on SiO₂ squares as the bottom substrate. The expected distributions of dye in the gap for pH 6 and pH 9 are shown in a 1D schematic in the bottom part of FIG. 14A. The expected distributions are based on the surface potential results for TiO₂ shown in FIG. 13D. In order to ensure substantial optical contrast in the measurement, use was made of a highly charged probe molecule, Atto 542c, expected to carry a nominal net electrical charge of q_{eff}=−3e.

FIG. 14B shows images of the dye fluorescent distribution (Atto542c, −3e charge) at pH 6 and pH 9 for low and high ionic strength solutions. A 3D intensity surface is shown for the center region of each pH 6 image to highlight the contrast due to the different surface potentials of SiO₂ (squares) and TiO₂ (grid lines). FIG. 14C shows intensity cross-sections through the center of the images in FIG. 14B.

At pH 6, which is close to the pI for TiO₂ and much larger than that of silica (pI<3), TiO₂ carries little charge (ψₛ≈0) while SiO₂ is expected to be substantially charged (ψₛ=−2.6±0.2 k_{B}T). At pH 9, however, both materials are expected to carry significant amounts of charge (|ψₛ|≥0.2 k_{B}T). This leads to a more marked contrast in optical intensity between the SiO₂ and TiO₂ regions of the coverslip for pH 6 compared to pH 9.

FIG. 14D shows measurement of the electrostatic contrast in the TiO₂/SiO₂ substrates as a function of changing pH, starting at a pH −9.5 solution and ending at a pH −3.5. This experiment demonstrates the ability of the system to optically image dynamic changes in charge and chemistry at the solid liquid interface. A starting state at t=0 is defined with an alkaline solution (pH 9.5) in the gap. A change in the pH is triggered by the addition of HCl, as depicted schematically in the leftmost part of FIG. 14D, which progressively changes the pH until the final pH of 3.5 is reached at t˜5 min. Following the introduction of acid, the system is imaged at 4 Hz using 10 ms exposure times per snapshot for a series of snapshots between t=0 and t˜5 min, as depicted in FIG. 14D. As protons diffuse through the system the surface groups respond to the local H₃O⁺ concentration in solution and protonate or deprotonate in response. This alters the local surface electrical potential and directly impacts the probe concentration in solution, and thus the measured local optical intensity. A wave of protons is observed diffusing through the field of view, originating from the location of the concentration perturbation. The timescale of the propagation is commensurate with the diffusion time of the hydronium ion and occurs over 3 min, which is overall rather slow. However, the time resolution of the acquisition tₑₓₚ=10 ms, suggests that much faster chemical and physical dynamics may be observed using this technique.

Demonstration of the opto-electrostatic measurement principle applied to a scanning probe system is now discussed. FIG. 15 is a schematic of an example scanning probe system for electrostatic contrast measurements of the TiO₂/SiO₂ substrates. In this example, the probe or the tip is a flat pyramidal silicon/SiO₂ structure of lateral dimension d˜300 μm and height H˜50-100 μm constructed by etching a silicon wafer. The height of the tip above the scanned substrate was monitored with nanometric control using white light interferometry. The SiO₂/TiO₂ patterned substrates were imaged by laterally scanning the substrate with respect to the Si/SiO₂ probe structure positioned at a height, H, above the substrate. Because the system permits the gap height to be varied it is possible to monitor and compare the optical signal at any spatial location on the substrate as a function of variable height, H. Similar to measurements in the lens-based system, strong optical contrast was observed between the TiO₂ and SiO₂ regions.

FIG. 16 shows images of the fluorescent distributions at two distinct heights of the scanning platform, for low and high ionic strength solutions at pH6, and low ionic strength solution at pH9, along with plots of line intensity profiles at each condition. At low salt concentrations (c=0.01 mM) a bright signal was observed from the regions corresponding to the TiO₂ grid lines at gap heights of h=50 nm, and a progressive increase in contrast was observed with increasing heights up to 500 nm. At even larger heights the contrast vanishes due to the reduction of the contribution of interfacial electrostatics relative to that from the probe molecule in bulk solution. In particular, an SNR on the contrast of ˜2.5 was observed in low ionic strength solution and pH 6(κ⁻¹=33 nm; H=50 nm). At higher salt concentrations, ca.100 mM (K⁻¹≈1 nm), the electrostatic contrast was observed to be large for gap heights, h<50 nm and disappeared entirely for h>50 nm as expected. The observations are all in line with the general expectation that the SNR of optical contrast is maximal at κh˜3 nm. Yet again, similar to the observations using the lens as a probe, no electrostatic contrast was detected between the SiO₂ and TiO₂ regions at pH 9, regardless of ionic strength, consistent with expectations based on homogenous thin film measurements and calculated images. Calculations were performed to determine the minimum feature size of a weakly charged material (such as TiO₂) that could be reliably measured against a highly charged background, similar to silica. This analysis showed that the electrostatic imaging approach can detect feature sizes on the order of ˜80 nm at a concentration of 0.1 mM NaCl(κ⁻¹ =33 nm; H=110 nm). The electrical contrast detected in this case corresponds to surface electrical potential differences of ψₛ˜0.5 (Φₛ˜12 mV) corresponding to a difference of surface charge of −5×10-3 e/nm 2 in 0.1 mM NaCl solution. In general, the minimal detectable feature size corresponds to about twice the Debye length in a system with H 2κ⁻¹. This further implies that the smallest discernible feature size, s, can be tuned by varying the ionic strength of the solution, i.e. s∝\sqrt{c}.

Thus, a simple optical technique has been demonstrated that offers large area electrical and chemical characterisation at submicron (spatial) and millisecond (temporal) resolution of a broad range of surface materials and thin films immersed in any solvent.

1. A method of measuring a surface charge distribution, comprising:
providing a liquid in contact with a target surface, the liquid containing charged entities;
detecting a concentration of the charged entities in a region between a probe member contacting the liquid and the target surface at each of a plurality of different positions on the target surface;
determining a surface charge distribution on the target surface using the detected concentrations.

2. The method of claim 1, wherein the detecting of concentrations comprises detecting a concentration for each of a plurality of different positions of the probe member relative to the target surface.

3. The method of claim 1, wherein the concentrations of the charged entities are detected optically.

4. The method of 1, wherein the charged entities are fluorescent.

5. The method of claim 4, wherein light is used to excite fluorescence of the charged entities during the detection of the concentrations of the charged entities.

6. The method of claim 1, wherein an external electrical potential is applied to the probe member, or a surface charge spontaneously arises on a surface of the probe member contacting the liquid, during the detection of the concentrations of charged entities.

7. The method of claim 1, wherein the surface charge distribution is detected for plural liquid compositions.

8. The method of claim 7, wherein the plural liquid compositions comprise compositions having different pH values and/or different ionic strengths.

9. The method of claim 1, wherein the determined surface charge distribution is spatially non-uniform.

10. A method of measuring an electrical property of entities in a liquid, comprising:
providing a liquid containing target entities in a region delimited by channel walls facing into the liquid, wherein the channel walls define a plurality of test regions in which a distance between the channel walls is different;
detecting concentrations of the target entities in the test regions; and
determining an electrical property of the target entities using the detected concentrations.

11. The method of claim 10, wherein the detecting of concentrations of the target entities comprises detecting how an average concentration of the target entities varies between the test regions.

12. The method of claim 10, wherein the test regions comprise nanoscale recesses acting as electrical potential wells with respect to the target entities.

13. The method of claim 12, wherein the detecting of the concentrations of the target entities in the test regions comprises detecting residence times of the target entities in the potential wells.

14. The method of claim 12, wherein a channel wall facing the nanoscale recesses is smoothly curved, thereby providing a range of different distances between the bases of the nanoscale recesses and the channel wall facing the nanoscale recesses.

15. The method of claim 10, further comprising:
providing a liquid containing reference entities in the region delimited by channel walls or an equivalent region delimited by channel walls, the reference entities having a known value of the electrical property; and
detecting concentrations of the reference entities in the test regions;
wherein the determination of the electrical property of the target entities is performed using the detected concentrations of the reference entities.

16. The method of claim 15, wherein the detecting of concentrations of the reference entities comprises detecting how an average concentration of the reference entities varies between test regions.

17. The method of claim 10, wherein the channel walls are configured such that the distance between the channel walls varies continuously as a function of position along the channel walls.

18. The method of 10, wherein an external electrical potential is applied to either or both of the channel walls, or a surface charge spontaneously arises on either or both of the channel walls.

19. The method of claim 10, wherein a single body of liquid extends through all of the test regions.

20. The method of claim 10, wherein the detections of the concentrations are performed optically.

21. A method of measuring an electrical property of entities in a liquid, comprising:
providing a liquid containing target entities in a region delimited by channel walls facing into the liquid, wherein at least one of the channel walls defines a plurality of nanoscale recesses acting as electrical potential wells with respect to the target entities, the distance between a base of a nanoscale recess and the channel wall facing the nanoscale recess being different for two or more of the nanoscale recesses;
detecting residence times of the target entities in the electrical potential wells; and
determining an electrical property of the target entities using the detected residence times.

22. The method of claim 21, wherein a channel wall facing the nanoscale recesses is smoothly curved, thereby providing a range of different distances between the bases of the nanoscale recesses and the channel wall facing the nanoscale recesses.

23. An apparatus for measuring a surface charge distribution, comprising:
a liquid handling apparatus configured to allow a liquid to be provided in contact with a target surface;
a probe member;
a detection system configured to detect a concentration of charged entities between the probe member and the target surface at each of a plurality of different positions on the target surface; and
an analysis unit configured to determine a surface charge distribution on the target surface using the detected concentrations of the charged entities.

24. An apparatus for measuring an electrical property of entities in a liquid, comprising:
a liquid handling apparatus configured to allow a liquid to be provided in a region delimited by channel walls facing into the liquid, wherein the channel walls define a plurality of test regions in which a distance between the channel walls is different;
a detection system configured to detect concentrations of target entities in the test regions; and
an analysis unit configured to determine an electrical property of the target entities using the detected concentrations.

25. An apparatus for measuring an electrical property of entities in a liquid, comprising:
a liquid handling apparatus configured to allow a liquid to be provided in a region delimited by channel walls facing into the liquid, wherein at least one of the channel walls defines a plurality of nanoscale recesses acting as electrical potential wells with respect to the target entities, the distance between a base of a nanoscale recess and the channel wall facing the nanoscale recess being different for two or more of the nanoscale recesses;
a detection system configured to detect residence times of the target entities in the electrical potential wells; and
an analysis unit configured to determine an electrical property of the target entities using the detected residence times.
